(19) United States
(12) Patent Application Publication
(10) Pub. No.: US 2014/0211389 A1
(43) Pub. Date: Jul. 31, 2014

(54) MOUNTING APPARATUS FOR CONNECTOR

(71) Applicants: HONG FU JIN PRECISION INDUSTRY (ShenZhen) CO., LTD., (US); HON HAI PRECISION INDUSTRY CO., LTD., New Taipei (TW)

(72) Inventors: WU ZHOU, Shenzhen (CN); JUN-HUI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/830,681

(22) Filed: Mar. 14, 2013

(30) Foreign Application Priority Data
Jan. 28, 2013 (CN) 201310031012.6

(51) Int. Cl. H01R 13/516

(52) U.S. Cl. CPC H01R 13/516
USPC 361/679.4

(57) ABSTRACT

An electronic device includes a chassis, a circuit board, a supporting bracket, a latching member, and a first connector. The chassis includes a bottom wall. The circuit board is mounted on the bottom wall, and includes a second connector. The supporting bracket is mounted on the bottom wall, adjacent to the second connector. The latching member is slidably mounted to the supporting bracket between a first position wherein the latching member is away from the first connector and located at a side of the supporting bracket, and a second position where the latching member extends out of the supporting bracket and abuts against the first connector toward the second connector.

### BACKGROUND

1. Technical Field

The present disclosure relates to an apparatus for fastening a connector.

2. Description of Related Art

Some connectors in electronic devices, such as serial advanced technology attachment (SATA) connectors, are mounted to a sidewall of an enclosure of the electronic device with screws. However, those screws are usually small and difficult to handle, and the installation of the connectors using screws in the computer is tedious.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of a mounting apparatus together with a connector, wherein the mounting apparatus includes a latching member.

FIG. 2 is similar to FIG. 1, but viewed from another perspective.

FIG. 3 is an enlarged view of the latching member of FIG. 1.

FIG. 4 is an assembled, isometric view of FIG. 1.

FIG. 5 is an assembled, isometric view of FIG. 2.

FIG. 6 is similar to FIG. 4, but showing the mounting apparatus in use.

FIG. 7 is similar to FIG. 5, but showing the mounting apparatus in use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

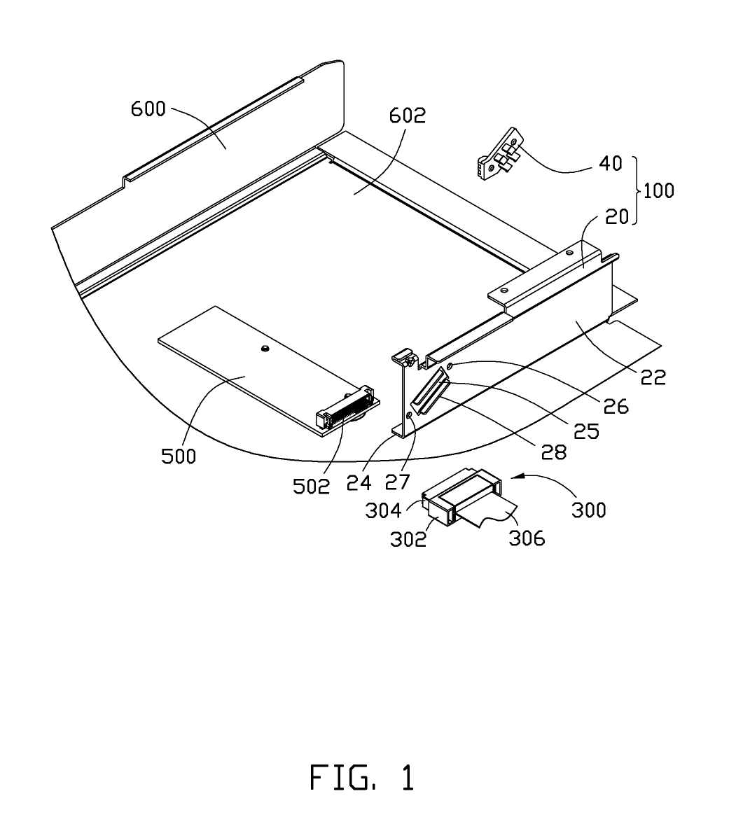

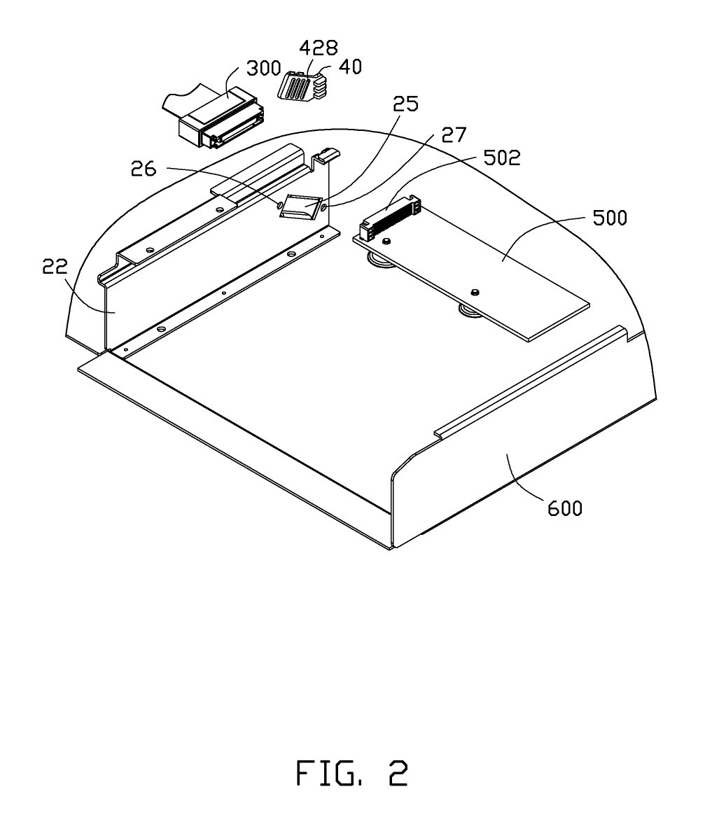

FIGS. 1 and 2 show an exemplary embodiment of an electronic device. The electronic device includes a chassis 600, a circuit board 500 mounted in the chassis 600, a mounting apparatus 100, and a connector 300. The chassis 600 includes a bottom wall 602. The connector 300 includes a main body 302, a connecting portion 304 protruding from a first side of the main body 302, and a cable 306 extending out from a second side of the main body 302 opposite to the connecting portion 304. The circuit board 500 includes a connector 502 mounted on an end of the circuit board 500.

The mounting apparatus 100 includes a supporting bracket 20 and a latching member 40.

The supporting bracket 20 includes a rectangular supporting plate 22 perpendicular to the bottom wall 602, and a connecting plate 24 perpendicularly protruding from a bottom side of the supporting plate 22. The connecting plate 24 is mounted on the bottom wall 602 of the chassis 600, adjacent to and facing the connector 502. One end of the supporting plate 22 defines a slot 25 slantingly extending up from the end of the supporting plate 22 toward an opposite end of the supporting plate 22, a first position hole 26 located adjacent to an upper end of the slot 25, and a second position hole 27 located adjacent to a lower end of the slot 25. Two flanges 28 protrude out from the supporting plate 22 away from the connector 502, at two opposite sides of the slot 25.

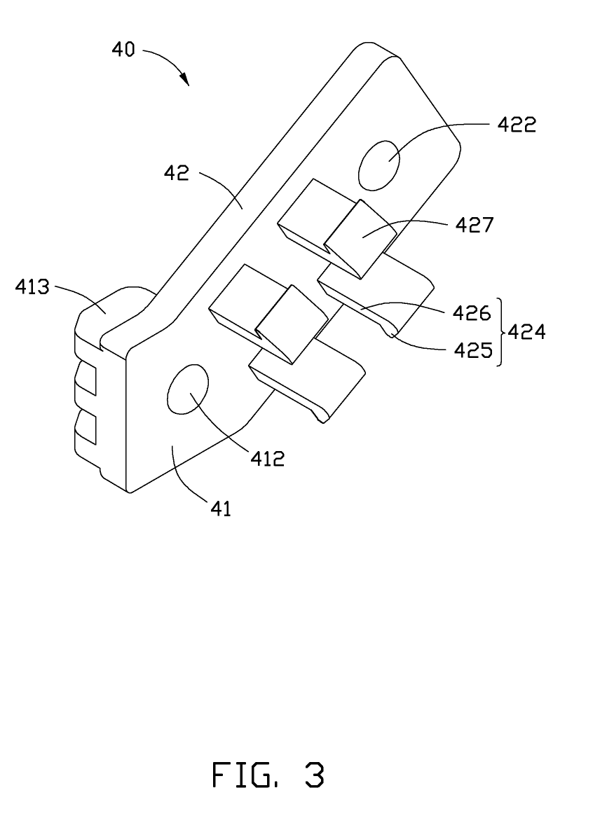

FIGS. 2 and 3 show that the latching member 40 includes a resilient abutting plate 41 and a resilient sliding plate 42 slanting extending up from a side of the abutting plate 41. A hemispherical first protuberance 422 protrudes from a first side of the sliding plate 42; adjacent to a distal end of the sliding plate 42 away from the abutting plate 41, and a hemispherical second protuberance 412 protrudes from a first side of the abutting plate 41 same with the first side of the sliding plate 42. Two rows of hooks 424 extend out from the first side of the sliding plate 42, between the first and second protuberances 422, 412, and each row is arranged along the extension direction of the sliding plate 42. Each hook 424 includes a resilient extending portion 426 extending from the sliding plate 42, and a wedge-shaped latching block 425 protruding out a distal end of the extending portion 426 away from the other row of hooks 424. An outer side of each latching block 425 defines a slanting guiding surface 427. An antiskid operation portion 428 protrudes from a second side of the sliding plate 42 opposite to the hooks 424. A plurality of rectangular abutting pieces 413 extends from a second side of the abutting plate 41, opposite to the second protuberance 412. In the embodiment, the latching member 40 is made of resilient material, such as a pliable plastic or rubber.

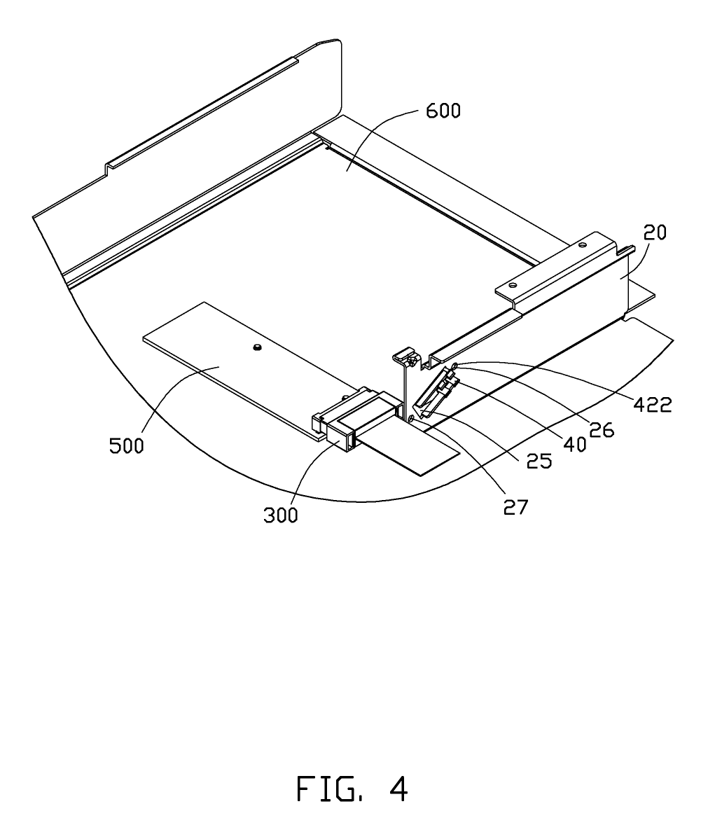

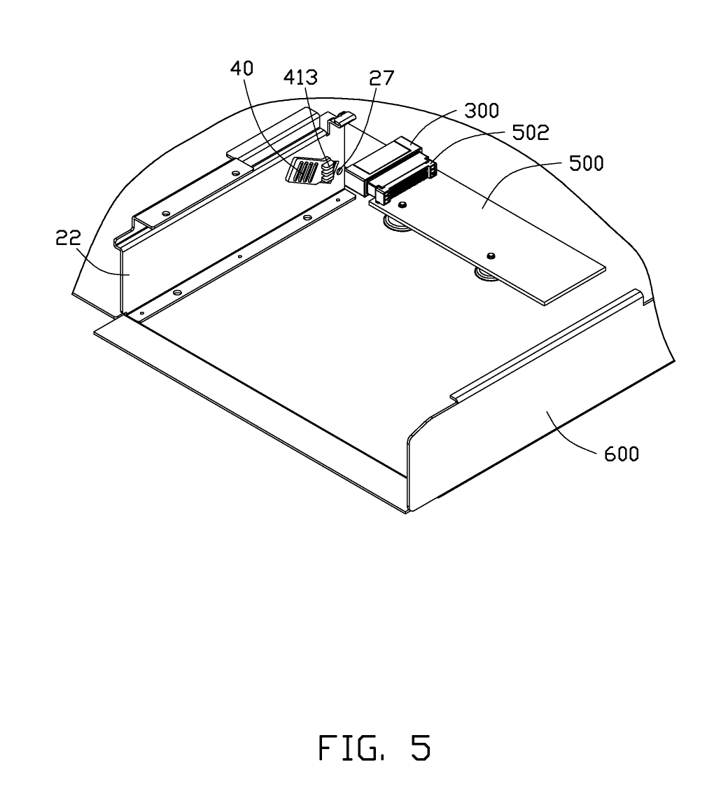

FIGS. 4 and 5 show that in assembly, the hooks 424 are inserted into the slot 25 from a side of the supporting bracket 20 adjacent to the connector 502. The guiding surfaces 427 of the hooks 424 slidably abutted against two inner surfaces of the guiding pieces 28, deforming the extending portions 426 of each row of hooks 424 toward the other row of hooks 424, until the latching blocks 425 pass over the flanges 28. The extending portions 426 of the hooks 424 are restored to bias the latching blocks 425 to slidably latch the corresponding flanges 28. Thereby, the latching member 40 can be slid along the slot 25 by manually operating the operation portion 428, to allow the first or second protuberance 422, 412 to be detachably latched into the first or second position hole 26, 27, with the abutting pieces 413 moving away from or moving adjacent to the connector 502.

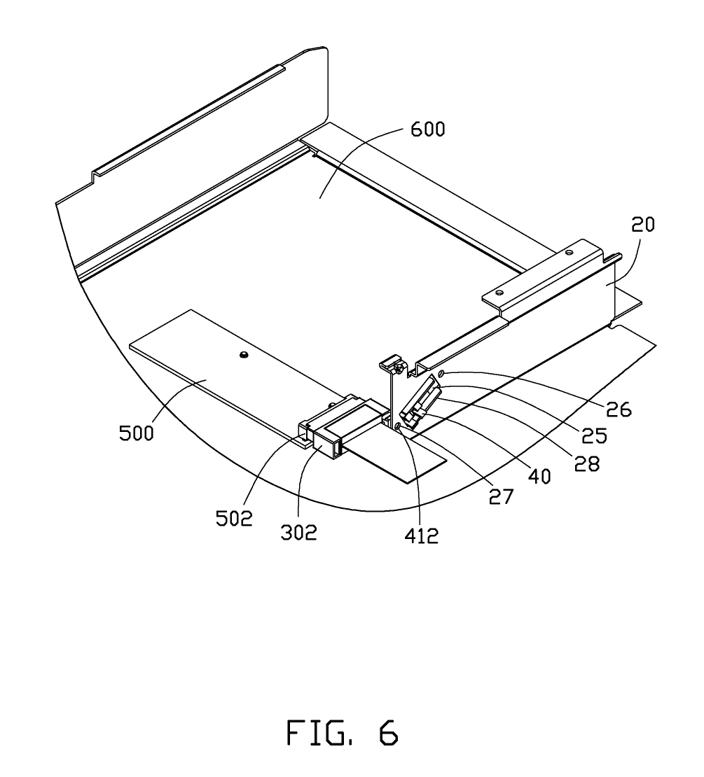

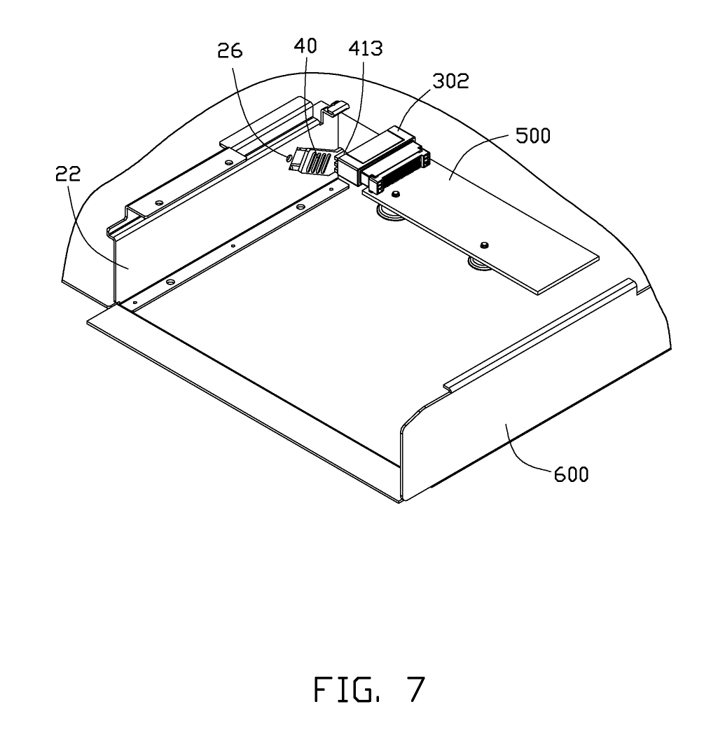

FIGS. 6 and 7 show that in use, the latching member 40 is slid away from the connector 502, and the first protuberance 422 is slidably abutted against the supporting plate 22, deforming the sliding plate 42, until the first protuberance 422 is latched into the first position hole 26 of the supporting bracket 20. The abutting plate 41 moves to an inner side of the supporting bracket 20. The connecting portion 304 of the connector 300 is inserted into the connector 502, and the main body 302 is located between the connector 502 and the mounting apparatus 100. The latching member 40 is slid toward the connector 300 by pushing the operation portion 428. The first protuberance 422 is detached from the first position hole 26, and the second protuberance 412 is slidably abutted against the supporting plate 22, deforming the abutting plate 41, until the second protuberance 412 is latched into the second position hole 27 of the supporting bracket 20. Thereby, the abutting plate 41 is extended out of the supporting plate 22, to allow the abutting pieces 413 to abut against the a side of the main body 302 opposite to the connecting portion 304.

If detaching the connector 300 from the connector 502 of the circuit board 500, the operation portion 428 is operated to move the latching member 40 away from the connector 300. The abutting pieces 413 disengage from the main body 302. The first protuberance 422 is latched into the first position hole 26. The connector 300 can be moved backwards to be detached from the connector 502.

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mounting apparatus for preventing a first connector from disengaging from a second connector, the mounting apparatus comprising:
a supporting bracket located adjacent to the second connector; and
a latching member slidably mounted on the supporting bracket,
wherein the latching member is movable between a first position where the latching member extends beyond the supporting bracket and abuts against the first connector toward the second connector when the first connector is engaged to the second connector, and a second position where the latching member is away from the first connector such that the first connector can be disengaged from the second connector.

2. The mounting apparatus of claim 1, wherein the supporting bracket comprises a supporting plate defining a first position hole and a second position hole, a first protuberance and a second protuberance protrude from the latching member, the first protuberance is detachably latched in the first position hole, and the second protuberance is detachably latched in the second position hole, wherein the first protuberance is latched in the first position hole when the latching member is in the first position, the second protuberance is latched in the second position hole when the latching member is in the second position.

3. The mounting apparatus of claim 2, wherein the first and second protuberances are hemispherical.

4. The mounting apparatus of claim 2, wherein the supporting plate defines a slot between the first position hole and the second position hole, the latching member is slid along the slot.

5. The mounting apparatus of claim 4, wherein the slot is slantingly defined in the supporting plate.

6. The mounting apparatus of claim 4, wherein the latching member comprises a resilient abutting plate and a resilient sliding plate extending from a side of the abutting plate, two hooks extend out from the sliding plate, the hooks are slidably latched to two opposite sides bounding the slot, the first protuberance is located at a distal end of the sliding plate opposite to the abutting plate, the second protuberance is located on the abutting plate.

7. The mounting apparatus of claim 6, wherein two flanges protrude out from the sides bounding the slot away from the second connector, each hook comprises a resilient extending portion extending from the sliding plate and a latching block protruding out a distal end of the extending portion, the extending portions are slidably received in the slot, and the latching blocks are slidably engaged with the flanges.

8. The mounting apparatus of claim 7, wherein an outer side of each latching block defines a slanting guiding surface.

9. The mounting apparatus of claim 6, wherein a plurality of abutting pieces extends from the abutting plate opposite to the second protuberance, the abutting pieces abuts again the second connector toward the first connector when the latching member is in the second position.

10. The mounting apparatus of claim 6, wherein an operation portion protrudes from the sliding plate opposite to the first protuberance.

11. An electronic device, comprising:
a chassis comprising a bottom wall;
a circuit board mounted on the bottom wall of the chassis, the circuit board comprising a first connector;
a supporting bracket mounted on the bottom wall of the chassis, adjacent to and facing the first connector;
a second connector; and
a latching member slidably mounted to the supporting bracket between a first position where the latching member is away from the first connector and located at a side of the supporting bracket, and a second position where the latching member extends out of the supporting bracket and abuts against the second connector toward the first connector;
wherein when the latching member is slid to the first position, the second connector can be inserted into the first connector; wherein when the latching member is slid to the second position, the latching member abuts against the second connector toward the first connector.

12. The electronic device of claim 11, wherein the supporting bracket comprises a supporting plate defining a first position hole and a second position hole, a first protuberance and a second protuberance protrude from the latching member, the first protuberance is detachably latched in the first position hole, and the second protuberance is detachably latched in the second position hole, wherein the first protuberance is latched in the first position hole when the latching member is in the first position, the second protuberance is latched in the second position hole when the latching member is in the second position.

13. The electronic device of claim 12, wherein the supporting plate defines a slot between the first position hole and the second position hole, the latching member is slid along the slot.

14. The electronic device of claim 13, wherein the latching member comprises a resilient abutting plate and a resilient sliding plate extending from a side of the abutting plate, two hooks extend out from the sliding plate, the hooks are slidably latched to two opposite sides bounding the slot, the first protuberance is located at a distal end of the sliding plate opposite to the abutting plate, the second protuberance is located on the abutting plate.

15. The electronic device of claim 14, wherein two flanges protrude out from the sides bounding the slot away from the second connector, each hook comprises a resilient extending portion extending from the sliding plate and a latching block protruding out a distal end of the extending portion, the extending portions are slidably received in the slot, and the latching blocks are slidably engaged with the flanges.
